(19) United States
(12) Patent Application Publication
(10) Pub. No.: US 2016/0355087 A1
(43) Pub. Date: Dec. 8, 2016

(54) STRADDLED ELECTRIC VEHICLE

(71) Applicant: YAMAHA HATSUDOKI KABUSHIKI KAISHA, Iwata-shi (JP)

(72) Inventor: Yuuichi YONEDA, Shizuoka (JP)

(21) Appl. No.: 15/164,948

(22) Filed: May 26, 2016

(30) Foreign Application Priority Data
Jun. 2, 2015 (JP) 2015-112567

(51) Int. Cl. B60K 17/02; B60K 17/24; B60K 17/14; B62K 11/00

(52) U.S. Cl. CPC B60K 17/02; B62K 11/00; B60K 17/24; B60K 17/145

(57) ABSTRACT

A straddled electric vehicle includes a power transmission mechanism that transmits driving power from a motor to a rear wheel. The power transmission mechanism includes a rear wheel shaft including spline grooves on its shaft surface, the spline grooves being inclined relative to an axial direction, a second gear including spline grooves engageable with the spline grooves, the second gear being capable of exchanging a rotating force with the rear wheel shaft, and an elastic member capable of biasing the second gear attached to the rear wheel shaft to the right. The spline grooves are inclined so as to move the second gear to the left when the rear wheel is rotating in the direction causing the straddled electric vehicle to advance and the second gear works to maintain the speed of rotation of the rear wheel as the speed of rotation is decreasing.

### BACKGROUND OF THE INVENTION

1. Field of the Invention

The present invention relates to a straddled electric vehicle. More particularly, the present invention relates to an off-road straddled electric vehicle.

2. Description of the Related Art

Straddled electric vehicles include electric motorcycles, for example. An electric motorcycle is disclosed in WO 2012/90245, for example. In the electric motorcycle disclosed in WO 2012/90245, driving power from the motor is transmitted to the rear wheel shaft via a power transmission mechanism to rotate the rear wheel.

An off-road straddled electric vehicle often travels on bad roads. As such, while the vehicle is travelling, irregularities on the road may cause the vehicle to jump such that the rear wheel leaves the ground. The rear wheel is under no-load conditions after the rear wheel leaves the ground due to a jump until it lands on the ground, and is then under a load again. That is, the magnitude of the load on the rear wheel dramatically changes. As the magnitude of the load on the rear wheel changes dramatically, an overcurrent flows in the motor. Thus, there may be a moment at which, even when the rider operates the throttle grip, the associated control may not be transmitted to the motor.

### SUMMARY OF THE INVENTION

In view of the above problems, preferred embodiments of the present invention provide a straddled electric vehicle that prevents overcurrent flowing when the load on the driving wheel dramatically changes.

A straddled electric vehicle according to a preferred embodiment of the present invention includes a motor, a driving wheel, and a power transmission mechanism including a plurality of shafts that transmit the driving power from the motor to the driving wheel. The power transmission mechanism includes a first shaft including a spline groove on its shaft surface, the spline groove being inclined relative to an axial direction; a rotating member attached to the first shaft and including a spline groove engageable with the spline groove on the first shaft, the rotating member capable of exchanging a rotating force with the first shaft; and an elastic member capable of biasing one of the rotating member attached to the first shaft and the first shaft toward one axial direction. The spline grooves are inclined so as to move the rotating member or the first shaft toward the other axial direction when the driving wheel is rotating in a direction causing the straddled electric vehicle to advance and the rotating member or the first shaft works to maintain a speed of rotation of the driving wheel as the speed of rotation is decreasing.

In the above arrangement, the first shaft engages the rotating member via the spline grooves that are inclined relative to the axial direction such that the rotating force of the rotating member acts in a direction inclined relative to the first shaft. Thus, a portion of the rotating force of the rotating member is transmitted to the shaft as a force causing the rotating member to move in an axial direction relative to the first shaft, and the remaining rotating force is transmitted to the shaft as a force causing the first shaft to rotate about its axis.

The power transmission mechanism further includes an elastic member that biases the rotating member or first shaft in one axial direction. When the motor is beginning to drive the rotating member, a portion of the rotating force of the rotating member is transmitted to the shaft as a force causing the rotating member to move in an axial direction relative to the first shaft. Thus, the elastic member is pushed by the rotating member or first shaft and increases its elastic force. When the elastic force of the elastic member increases, a portion of the rotating force of the rotating member (i.e., a rotating force acting in an axial direction) and the elastic force of the elastic member are eventually brought into balance such that the rotating member and first shaft do not move relative to each other any more in an axial direction. Thus, the rotating force of the rotating member is transmitted as a force causing the first shaft to rotate about the axis.

In this state, while the vehicle is travelling, the magnitude of the load on the driving wheel may decrease such that the driving wheel is under or substantially under no-load conditions, which increases the speed of rotation of the driving wheel from that encountered during normal travelling. Further, if the magnitude of the load on the driving wheel decreases such that the wheel is under or substantially under no-load conditions, the rotating member or first shaft is caused by the elastic force of the elastic member to move in one direction.

Subsequently, when a large load is suddenly applied to the driving wheel once again, the driving wheel may stop rotating temporarily. When the driving wheel suddenly stops, the first shaft or rotating member moves in the axial direction that is opposite the one direction due to the effects of the spline grooves, and continue to rotate while squeezing the elastic member. That is, there is a rotation phase difference between the rotation of the rotating member and that of the first shaft. When there is a rotation phase difference between the rotation of the rotating member and that of the first shaft, there is a time lag between the time at which the effect of the load applied to the driving wheel (that is, temporary halt of the first shaft) occurs and the time at which this effect affects the driving of the motor (that is, the rotation of the rotating member). This prevents an overcurrent flowing in the motor due to a load suddenly applied to the driving wheel.

Preferably, the rotating member or the first shaft of a straddled electric vehicle according to a preferred embodiment of the present invention moves in the other axial direction while resisting an elastic force of the elastic member.

Preferably, when the rotating member or the first shaft of a straddled electric vehicle according to a preferred embodiment of the present invention is not transmitting the driving power to the driving wheel, the elastic member applies essentially no elastic force to the rotating member or the first shaft.

In the above arrangement, when the rotating member or first shaft is not transmitting driving power to the driving wheel, the elastic member applies essentially no elastic force to the rotating member or first shaft. Thus, when the rotating member or first shaft of the straddled electric vehicle transitions to such a state, it is immediately possible to tolerate a phase difference between the rotation of the rotating member and that of the first shaft. Problems may occur if the vehicle is not in the above arrangement, i.e., if the vehicle is constructed such that, when the rotating member or first shaft is not transmitting driving power to the driving wheel, the elastic member exerts a certain elastic force to the rotating member or first shaft. That is, until the driving power transmitted by the rotating member or first shaft via the spline grooves exceeds a certain elastic force, it cannot squeeze the elastic member, causing no phase difference in rotation. The rotating member or first shaft not transmitting driving power to the driving wheel means not only the motor not rotating, but also the driving wheel being rotated by a force other than driving power transmitted from the motor when the driving wheel is off the ground or the vehicle is travelling on a downward slope, for example.

Preferably, out of the rotating member and the first shaft of a straddled electric vehicle according to a preferred embodiment of the present invention, the rotating member moves in the other axial direction.

In the above arrangement, the rotating member is movable, which prevents the bearing structure from becoming complicated compared with implementations where the first shaft moves. Further, since out of the rotating member and first shaft, the rotating member is movable, the object pushed by the elastic member via its elastic force is the rotating member. Since the rotating member has a diameter larger than that of the first shaft, the structure used by the elastic member to apply an elastic force to the object is prevented from becoming complicated.

Preferably, the elastic member of a straddled electric vehicle according to a preferred embodiment of the present invention is a disc spring that applies an elastic force pushing the rotating member in the one direction.

In the above arrangement, due to the large elastic modulus of a disc spring, the spring has a large elastic force even if elastic deformation is small. Since driving power including a large torque is transmitted to the driving shaft by the power transmission mechanism, a disc spring with a large elastic modulus is suitable for the elastic member.

Preferably, the plurality of shafts of a straddled electric vehicle according to a preferred embodiment of the present invention include a motor shaft capable of being rotated by the driving power of the motor and a driving shaft capable of rotating the driving wheel, wherein the first shaft is the driving shaft.

In the above arrangement, in the driving power transmission mechanism, the speed of rotation decreases when driving power is transmitted from the motor shaft to the driving shaft. In other words, speed increases as it goes toward the motor shaft from the driving shaft. Thus, even if the rotating member or first shaft is moved due to the inclined spline grooves in an axial direction by a small distance, it is possible to efficiently reduce effects on the motor. That is, the size thereof as measured in the vehicle width direction is able to be reduced.

Preferably, the plurality of shafts of a straddled electric vehicle according to a preferred embodiment of the present invention further includes an intermediate shaft capable of transmitting the driving power transmitted from the motor shaft to the driving shaft, wherein the rotating member engaging the driving shaft is a gear coaxial with the driving shaft.

In the above arrangement, the driving power transmission mechanism includes an intermediate shaft between the motor shaft and driving shaft, and the inclined spline grooves are located distant from the motor shaft. Thus, the inertia of the rotating member rotating together with the motor shaft increases. This reduces effects on the motor more efficiently.

In this case, preferably, the spline grooves provided on the driving shaft and the rotating member of a straddled electric vehicle according to a preferred embodiment of the present invention are inclined relative to the axial direction by about 40 degrees to about 50 degrees, for example.

In the above arrangement, a portion of the driving power transmitted to the driving shaft from the rotating member is able to be efficiently directed to an axial direction of the driving shaft.

The plurality of shafts of a straddled electric vehicle according to a preferred embodiment of the present invention may include a motor shaft capable of being rotated by the driving power of the motor, a driving shaft capable of rotating the driving wheel, and an intermediate shaft capable of transmitting the driving power transmitted from the motor shaft to the driving shaft, wherein the first shaft may be the intermediate shaft.

The plurality of shafts of a straddled electric vehicle according to a preferred embodiment of the present invention may include a motor shaft capable of being rotated by the driving power of the motor and a driving shaft capable of rotating the driving wheel, wherein the first shaft may be the motor shaft, and the rotating member engaging the motor shaft may be a member including a rotor of the motor.

In this case, preferably, the elastic member of the straddled electric vehicle biases the motor shaft toward the one direction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of an electric motorcycle according to a first preferred embodiment of the present invention.

FIG. 2 is a left side view of a drive unit according to the first preferred embodiment of the present invention.

FIG. 3 of a cross-sectional view of the drive unit taken along line III-III of FIG. 2.

FIG. 4 is an enlarged view of the main components of FIG. 3, illustrating a first state of a mechanism to tolerate a rotation phase difference.

FIG. 5 is an enlarged view of the main components of FIG. 3, illustrating a second state of a mechanism to tolerate a rotation phase difference.

FIG. 6 is a cross-sectional view of a drive unit according to a second preferred embodiment of the present invention.

FIG. 7 is a cross-sectional view of a drive unit according to a third preferred embodiment of the present invention.

### DETAILED DESCRIPTION OF THE PREFERRED EMBODIMENTS

An off-road straddled electric vehicle often travels on bad roads. As such, while the vehicle is travelling, irregularities on the road may cause the vehicle to jump such that the rear wheel leaves the ground. When the rider does not intend the rear wheel to leave the ground, the rear wheel may leave the ground with the throttle grip fully turned. In this case, driving power from the motor continues to be transmitted to the rear wheel shaft.

When the rear wheel leaves the ground, there is no friction any more acting between the ground and rear wheel, causing the rear wheel to slip. As the rear wheel is slipping, the speed of rotation of the motor rapidly increases.

When the rear wheel leaves the ground and becomes under no-load conditions and then the rear wheel contacts the ground, friction between the rear wheel and ground causes a load on the rear wheel shaft once again. Since the rear wheel shaft suddenly transitions from a no-load condition to a load condition, the rear wheel stops rotating for a certain period of time. That is, the rotation of the rotor of the motor connected to the rear wheel shaft suddenly stops.

When the rotor of the motor suddenly stops rotating, it increases the magnetic field between the rotor and stator to compensate for the rotor suddenly stopping, which increases the magnitude of current flowing in the stator (that is, an overcurrent flows). When the magnitude of overcurrent exceeds a predetermined threshold, controls associated with the throttle grip operated by the rider may not be transmitted to the motor temporarily between the time at which the magnitude of current exceeds the threshold and the time at which it returns to the original level.

In view of the above problems, the present inventors investigated what structure would not transmit sudden changes in the load on the rear wheel to the motor in a direct manner. The inventors discovered that providing, in the power transmission mechanism, a mechanism that tolerates a rotation phase difference on the driving transmission path between the motor and rear wheel will prevent sudden changes in the load on the rear wheel from being directly transmitted to the motor.

Preferred embodiments of the present invention will be described in detail with reference to the drawings. For ease of explanation, the drawings which will be referred to in the description below schematically show only those of the components of the preferred embodiments of the present invention that are the main components necessary to illustrate the present invention. As such, the present invention may include any component not shown in any of the drawings. Further, the sizes of the components in the drawings do not exactly represent the actual sizes and size ratios of the components.

### First Preferred Embodiment

A straddled electric vehicle according to a preferred embodiment of the present invention will be described below with reference to the drawings. The present preferred embodiment will be described in connection with an electric motorcycle as an example of the straddled electric vehicle. The same or corresponding elements in the drawings are labeled with the same characters and their description will not be repeated.

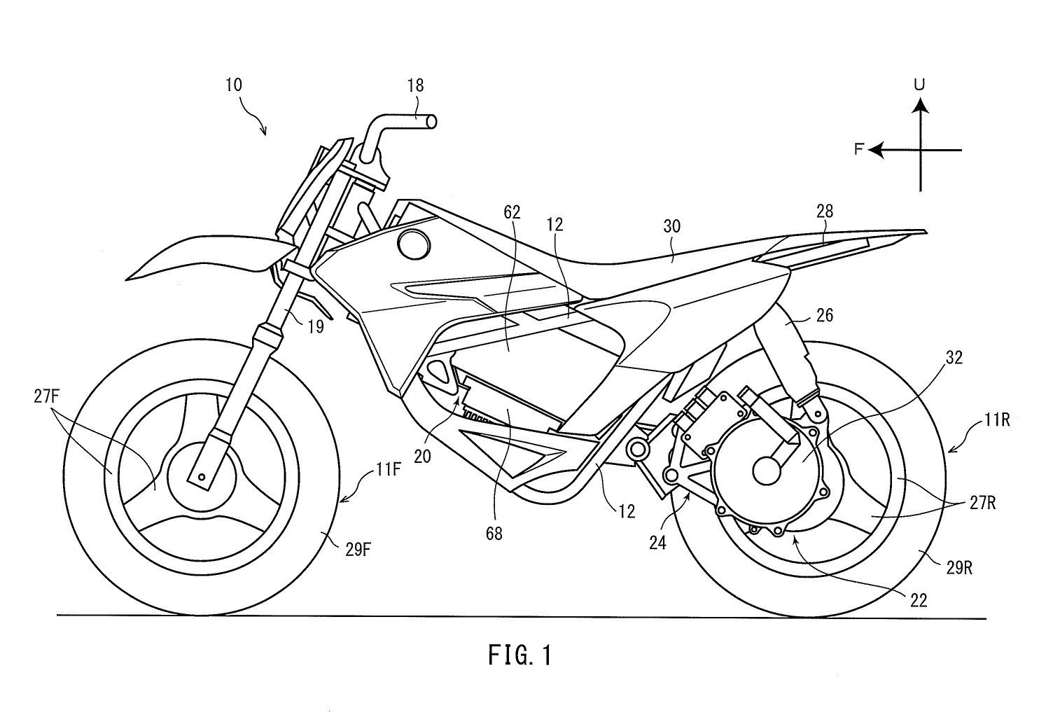

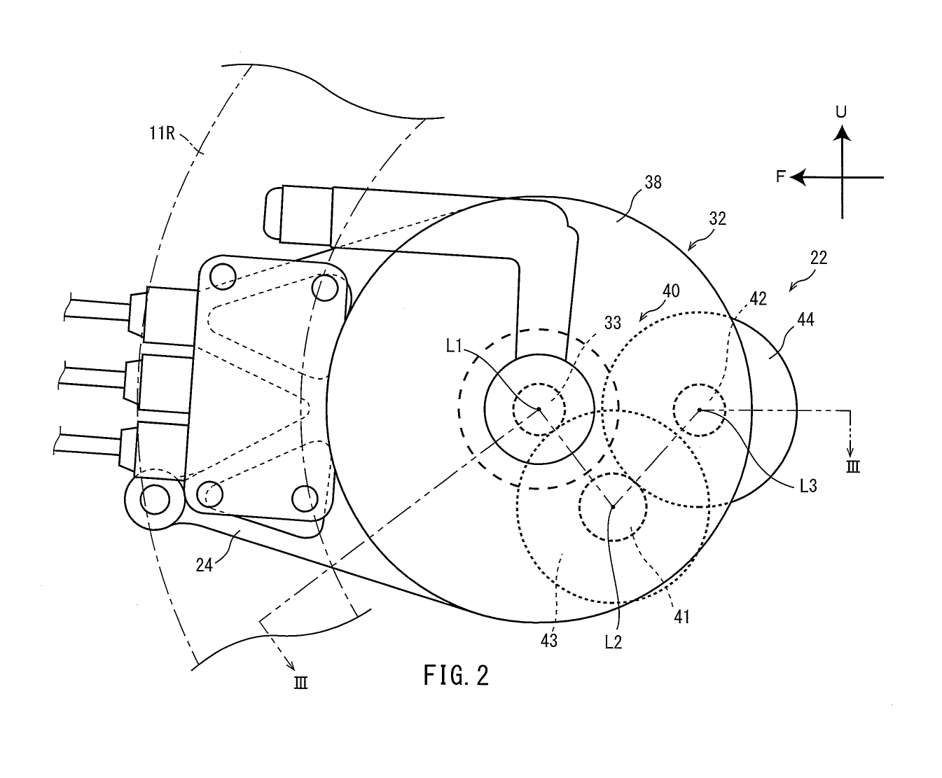

FIG. 1 is a left side view of an electric motorcycle 10 according to a preferred embodiment of the present invention. In the description below, forward/front, rear(ward), left and right means such directions as perceived by a rider sitting on the seat 30 of the electric motorcycle 10. In FIG. 1, arrow F indicates the forward direction with respect to the electric motorcycle 10, while arrow U indicates the upward direction with respect to the electric motorcycle 10 (the same applies to FIG. 2 below).

The overall construction of the electric motorcycle 10 will be described with reference to FIG. 1. The electric motorcycle 10 includes a front wheel 11F, a rear wheel 11R, a vehicle body frame 12, handlebars 18, a front fork 19, a battery unit 20, a drive unit 22, a rear arm 24, a rear cushion 26, a vehicle body cover 28, and a seat 30.

The front wheel 11F includes a wheel body 27F and a front wheel tire 29F. The rear wheel 11R includes a wheel body 27R and a rear wheel tire 29R.

The front fork 19 supports the front wheel 11F such that it is rotatable. Operating the handlebars 18 changes the direction of the front wheel 11F.

The vehicle body frame 12 supports the rear arm 24 such that it is able to swing in the top/bottom direction. The rear arm 24 supports the rear wheel 11R such that it is rotatable. The rear cushion 26 is located between the rear arm 24 and vehicle body frame 12. The drive unit 22 is provided on the rear arm 24. The drive unit 22 is located in the vicinity of the rear wheel 11R. That is, the electric motorcycle 10 includes a so-called unit-swing driving structure.

As shown in FIG. 1, the vehicle body frame 12 supports the battery unit 20. The battery unit 20 includes a battery (not shown), a battery case 62 containing the battery, and a controller 68. Electric power stored in the battery is supplied to the drive unit 22 via the controller 68. This drives the drive unit 22.

The drive unit 22 includes a motor 32. Driving power from the drive unit 22 is transmitted to the rear wheel 11R. This rotates the rear wheel 11R.

The vehicle body frame 12 supports the vehicle body cover 28. The vehicle body cover 28 covers a portion of the vehicle body frame 12 in a side view of the vehicle.

The vehicle body frame 12 supports the seat 30. The seat 30 is located above the vehicle body frame 12.

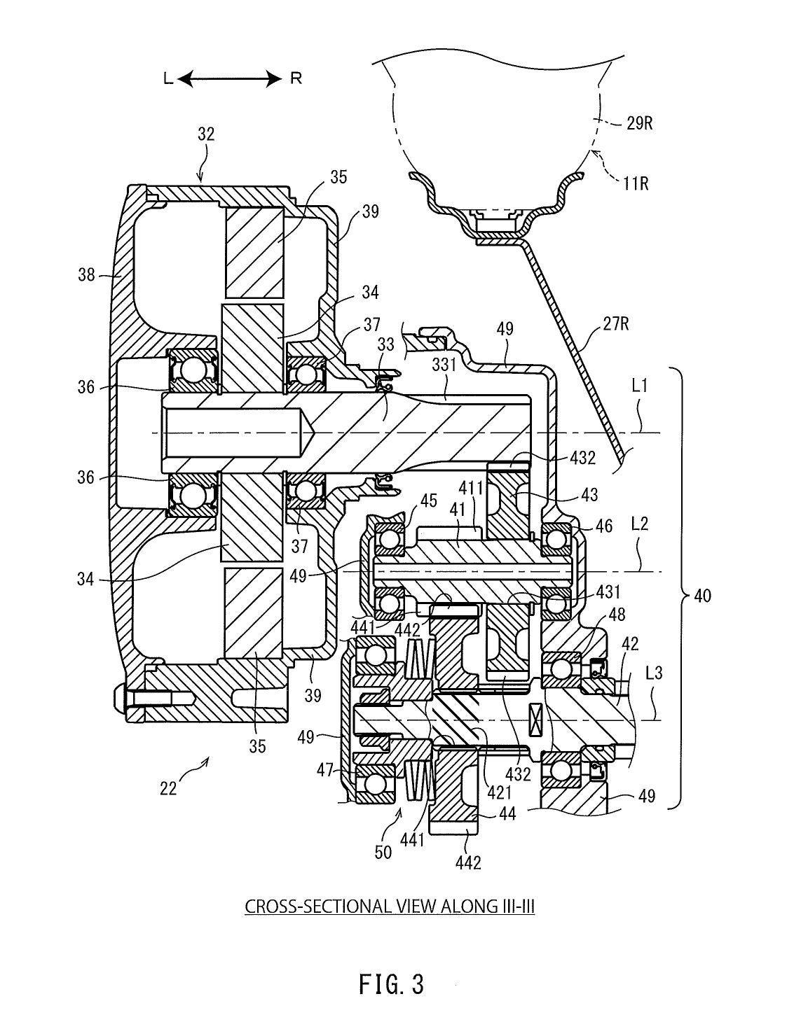

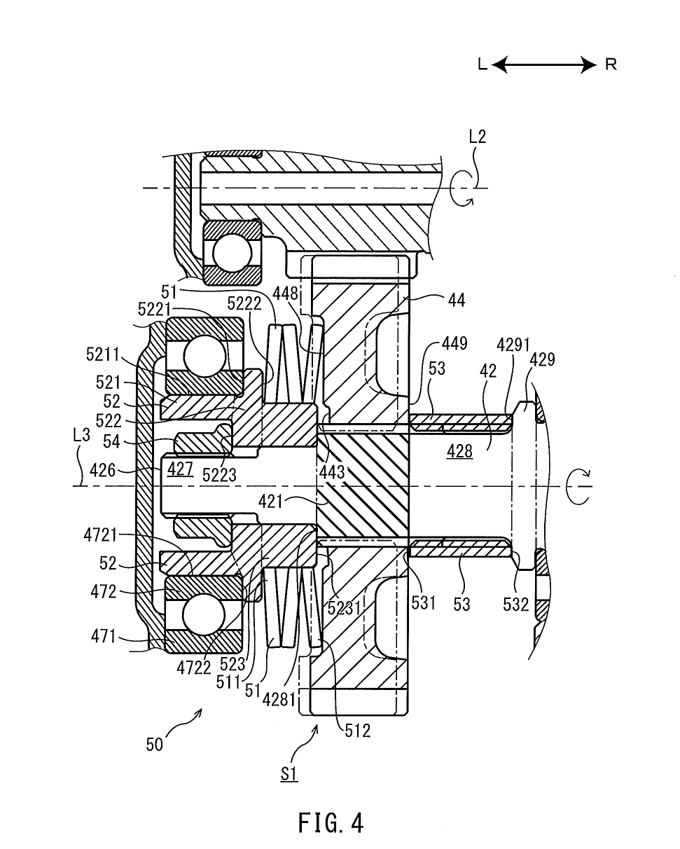

FIG. 2 is a left side view of the drive unit 22. FIG. 3 is a cross-sectional view of the drive unit 22 taken along line III-III of FIG. 2. In FIG. 3, arrow R indicates the right direction with respect to the electric motorcycle 10, while arrow L indicates the left direction with respect to the electric motorcycle 10 (the same applies to FIGS. 4 to 7 below). The drive unit 22 will be described with reference to FIGS. 2 and 3. As shown in FIG. 3, the drive unit 22 includes the motor 32 and a power transmission mechanism 40.

As shown in FIG. 3, the motor 32 includes a motor shaft 33, a rotor 34, a stator 35, a bearing 36, a bearing 37, a first motor case portion 38, and a second motor case portion 39.

The motor shaft 33 is positioned with its shaft center consistent with an axis L1 extending in the left/right direction. The bearing 36 is located between the motor shaft 33 and first motor case portion 38. The bearing 37 is located between the motor shaft 33 and second motor case portion 39. Thus, the motor shaft 33 is supported on the first and second motor case portions 38 and 39 by the bearings 36 and 37, and is rotatable about the axis L1. As the motor 32 rotates, the motor shaft 33 rotates in the forward direction.

The rotor 34 is cylindrical in shape. The rotor 34 is positioned around the motor shaft 33. Similar to the motor shaft 33, the rotor 34 is positioned with its shaft center consistent with the axis L1. The rotor 34 is rotatable together with the motor shaft 33 about the axis L1.

The stator 35 is cylindrical in shape. The stator 35 is positioned around the rotor 34. Similar to the motor shaft 33 and rotor 34, the stator 35 is positioned with its shaft center consistent with the axis L1. The stator 35 is fixed to the second motor case portion 39. Although not shown, the stator 35 includes a stator body and a plurality of cores, for example.

The first motor case portion 38 is generally circular in shape in side view. The second motor case portion 39 is generally cylindrical in shape with its height oriented in the left/right direction. The second motor case portion 39 includes an open left portion. The first motor case portion 38 is fitted into the opening of the second motor case portion 39. The second motor case portion 39 includes a right portion that is circular in side view. The circular right portion of the second motor case portion 39 has a hole at its center. The motor shaft 33 extends through the hole in the right portion of the second motor case portion 39. As shown in FIG. 3, in the space defined by the second motor case portion 39 and the first motor case portion 38 fitted into it are positioned a left portion of the motor shaft 33, the rotor 34, the stator 35 and the bearings 36 and 37.

As shown in FIGS. 2 and 3, the power transmission mechanism 40 includes the motor shaft 33 of the motor 32, an intermediate shaft 41, a rear wheel shaft (or driving shaft) 42, a first gear 43, and a second gear 44. The power transmission mechanism 40 receives driving power produced by the rotation of the motor 32 and transmits it to the rear wheel shaft 42 via the intermediate shaft 41. Driving power produced by the rotation of the motor 32 is transmitted to the rear wheel shaft 42 with its torque amplified.

As discussed above, the motor shaft 33 defines a portion of the motor 32. As shown in FIG. 3, the left portion of the motor shaft 33 is located in the space defined by the first and second motor case portions 38 and 39 of the motor 32. The motor shaft 33 extends through the second motor case portion 39. The motor shaft 33 includes a right portion protruding toward the right of the motor 32. A plurality of gear grooves 331 extending parallel or substantially parallel to each other are provided on the surface of the right portion of the motor shaft 33. The gear grooves 331 extend parallel or substantially parallel to the axis L1.

As shown in FIGS. 2 and 3, the intermediate shaft 41 is positioned with its shaft center consistent with an axis L2 extending in the left/right direction. As shown in FIG. 3, the intermediate shaft 41 is supported on the housing 49 by bearings 45 and 46. The bearings 45 and 46 make the intermediate shaft 41 rotatable about the axis L2. A plurality of gear grooves 411 extending parallel or substantially parallel to each other are provided on a portion of the surface of the intermediate shaft 41. The gear grooves 411 extend parallel or substantially parallel to the axis L2.

The first gear 43 is attached to the intermediate shaft 41. The first gear 43 is annular in shape. The inner periphery 431 of the first gear 43 is fixed to the surface of the intermediate shaft 41. Gear grooves may be provided on the inner periphery 431 of the first gear 43 and spline grooves may be provided on the surface of the intermediate shaft 41, in which case the gear grooves may engage the spline grooves to fix the first gear 43 to the intermediate shaft 41.

A plurality of gear grooves 432 extending parallel or substantially parallel to each other are provided on the outer periphery of the first gear 43. The gear grooves 432 extend parallel or substantially parallel to the axis L2. The gear grooves 432 engage the gear grooves 331 on the surface of the motor shaft 33. Thus, as the motor shaft 33 rotates in the forward direction, the first gear 43 rotates in the rearward direction. That is, as the motor shaft 33 rotates in the forward direction, the intermediate shaft 41 rotates in the rearward direction.

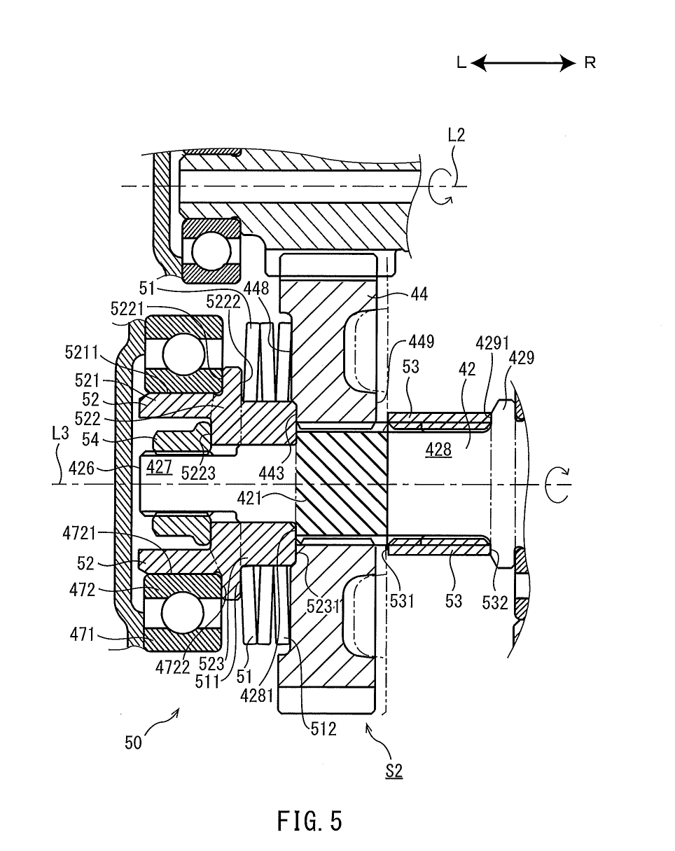

As shown in FIGS. 2 and 3, the rear wheel shaft 42 is positioned with its shaft center consistent with an axis L3 extending in the left/right direction. As shown in FIG. 3, the rear wheel shaft 42 is supported on the housing 49 by bearings 47 and 48. The bearings 47 and 48 make the rear wheel shaft 42 rotatable about the axis L3. A plurality of spline grooves 421 extending parallel or substantially parallel to each other are provided on a portion of the surface of the rear wheel shaft 42. The spline grooves 421 are inclined relative to the axis L3. For convenience, FIG. 3 shows the area where the spline grooves 421 are coupled to the second gear 44 as a line parallel or substantially parallel to the axis L3 (such portions are shown in FIGS. 4 and 5 in a similar manner).

The wheel body 27R shown in FIG. 3 is fixed to the rear wheel shaft 42 (the fixed portions are not shown). The wheel body 27R is positioned with its shaft center consistent with the axis L3. The rear wheel shaft 42 is fixed to the center of the wheel body 27R. Thus, the wheel body 27R is able to rotate in synchronization with the rotation of the rear wheel shaft 42. That is, the rear wheel 11R is able to rotate in synchronization with the rotation of the rear wheel shaft 42.

The second gear 44 is attached to the rear wheel shaft 42. The second gear 44 is annular in shape. A plurality of spline grooves 441 extending parallel or substantially parallel to each other are provided on the inner periphery of the second gear 44. The spline grooves 441 are inclined relative to the axis L3. As discussed further below, the spline grooves 441 engage the spline grooves 421 on the rear wheel shaft 42.

A plurality of gear grooves 442 extending parallel or substantially parallel to each other are provided on the outer periphery of the second gear 44. The gear grooves 442 extend parallel or substantially parallel to the axis L3. The gear grooves 442 engage the gear grooves 411 on the surface of the intermediate shaft 41. Thus, as the intermediate shaft 41 rotates in the rearward direction, the second gear 44 rotates in the forward direction. That is, as the motor shaft 33 rotates in the forward direction, the intermediate shaft 41 rotates in the rearward direction and the rear wheel shaft 42 rotates in the forward direction.

A mechanism that tolerates a rotation phase difference, 50, is provided around the location where the spline grooves 421 on the rear wheel shaft 42 engage the spline grooves 441 on the second gear 44. FIG. 4 is an enlarged view of the mechanism 50 that tolerates a rotation phase difference of FIG. 3. FIG. 4 shows a first state S1 of the mechanism 50 that tolerates a rotation phase difference. As shown in FIG. 4, the mechanism 50 that tolerates a rotation phase difference preferably includes the rear wheel shaft 42, the second gear 44, a member 52, a member 53, a member 54, and an elastic member 51. FIG. 5 shows a second state S2 of the mechanism 50 that tolerates a rotation phase difference. The mechanism 50 that tolerates a rotation phase difference is able to be switched between the first state S1 shown in FIG. 4 and the second state S2 shown in FIG. 5 depending on the travel condition of the elastic motorcycle 10.

As shown in FIG. 4, a portion of the rear wheel shaft 42 that includes its left end surface 426 defines a first portion 427. A portion of the rear wheel shaft 42 that is connected to the first portion 427 defines a second portion 428, while a portion thereof that is connected to the second portion 428 defines a third portion 429. In FIG. 4, the borders between the first, second and third portions 427, 428 and 429 are shown by chain lines.

The diameter of a cross section of the first portion 427 perpendicular or substantially perpendicular to the axis L3 is smaller than the diameter of the second portion 428. Thus, as the first and second portions 427 and 428 are connected, portions of the left side of the second portion 428 are exposed to form an annular step 4281. Further, the diameter of a cross section of the second portion 428 perpendicular to the axis L3 is smaller than the diameter of the third portion 429. Thus, as the second and third portions 428 and 429 are connected, portions of the left side of the third portion 429 are exposed to form an annular step 4291.

The annular member 52 is attached to the rear wheel shaft 42 and is located to the left of the second gear 44. The annular member 53 is attached to the rear wheel shaft 42 and is located to the right of the second gear 44. The annular member 54 is attached to the rear wheel shaft 42 and is located to the left of the member 52. The members 52, 53 and 54 are positioned with their shaft center consistent with the axis L3. The members 52, 53 and 54 rotate together with the rear wheel shaft 42 about the axis L3.

As shown in FIG. 4, the member 52 is made up of a left portion 521, an intermediate portion 522 and a right portion 523. The left, intermediate and right portions 521, 522 and 523 are integrally formed. The left, intermediate and right portions 521, 522 and 523 are annular in shape. The inner peripheries of the intermediate and right portions 522 and 523 of the member 52 are fixed to the rear wheel shaft 42. The member 52 is fixed to the rear wheel shaft 42 as it is tightened up by the member 54 by clearance fitting.

The left portion 521 of the member 52 defines a left portion of the member 52. The outer periphery 5211 of the left portion 521 is fixed to the bearing 47. The bearing 47 includes an outer ring 471 and an inner ring 472. The outer periphery 5211 of the left portion 521 is fixed to the inner periphery 4721 of the inner ring 472 of the bearing 47. The left portion 521 is fixed to the inner ring 472 by clearance fitting.

The right portion 523 of the member 52 defines a right portion of the member 52. The right side 5231 of the right portion 523 is in contact with the step 4281 on the rear wheel shaft 42.

The elastic member 51 is attached to the outer periphery of the right portion 523 of the member 52. The elastic member 51 will be described in detail further below.

The intermediate portion 522 of the member 52 is a structure between the left and right portions 521 and 523. The outer diameter of a cross section of the intermediate portion 522 perpendicular or substantially perpendicular to the axis L3 is larger than the outer diameter of a cross section of the left portion 521. Thus, as the left and intermediate portions 521 and 522 are connected, a left side 5221 of the intermediate portion 522 is provided. The left side 5221 of the intermediate portion 522 is in contact with the right side 4722 of the inner ring 472.

The inner diameter of a cross section of the intermediate portion 522 perpendicular or substantially perpendicular to the axis L3 is smaller than the inner diameter of a cross section of the left portion 521. Thus, as the left and intermediate portions 521 and 522 are connected, a left side 5223 of the intermediate portion 522 is provided.

Further, the outer diameter of a cross section of the intermediate portion 522 perpendicular or substantially perpendicular to the axis L3 is larger than the outer diameter of a cross section of the right portion 523. Thus, as the right and intermediate portions 523 and 522 are connected, a right side 5222 of the intermediate portion 522 is provided.

As shown in FIG. 4, the inner periphery 542 of the member 54 is fixed to the surface of the rear wheel shaft 42. The member 54 is fixed to the rear wheel shaft 42 via a thread. The right side 541 of the member 54 is in contact with the left side 5223 of the intermediate portion 522. As the member 54 is located generally to the left of the member 52, the member 52 is sandwiched between the step 4281 of the rear wheel shaft 42 and the member 54, thus restricting its movement in the direction of the axis L3.

As shown in FIG. 4, the member 53 is located to the right of the second gear 44. The member 53 is fixed to the rear wheel shaft 42 via spline grooves. The right side 532 of the member 53 is in contact with the step 4291 of the rear wheel shaft 42.

The distance between the right side 5231 of the right portion 523 of the member 52 and the left side 531 of the member 53 is larger than the size of the second gear 44 as measured in the direction of the axis L3. Thus, the second gear 44 is movable in the direction of the axis L3 between the members 52 and 53.

As discussed above, as shown in FIG. 4, the elastic member 51 is located on the outer periphery of the right portion 523 of the member 52. The elastic member 51 is annular in shape. The elastic member 51 is able to be extended and contracted in the direction of the axis L3. The elastic member 51 may be a disc spring, for example.

The left end 511 of the elastic member 51 is in contact with the right side 5222 of the intermediate portion 522 of the member 52. The right end 512 of the elastic member 51 is in contact with the left side 448 of the second gear 44. The left end 511 of the elastic member 51 may be fixed to the right side 5222 of the intermediate portion 522 by an adhesive, for example. The right end 512 of the elastic member 51 may be fixed to the left side 448 of the second gear 44 by an adhesive, for example.

When no external force is applied to the elastic member 51, the right side 449 of the second gear 44 is in contact with the left side 531 of the member 53, as shown in FIG. 4. This state will be referred to as first state S1. When a force toward the left is applied by the second gear 44 to the elastic member 51, the elastic member 51 is contracted such that the left side 443 of the second gear 44 is close to the right side 5231 of the right side 523 of the member 52. This state will be referred to as second state S2. In the second state S2, the component of the rotating force from the second gear 44 that is in the direction of the axis L3 and the elastic force of the elastic member 51 are opposite to each other and have an equal magnitude, i.e., they are in balance. In reality, the distance between the left side 443 of the second gear 44 and the right side 5231 of the right portion 523 of the member 52 is very small, and, in view of this, FIG. 5 shows the left side 443 of the second gear 44 and the right side 5231 of the right portion 523 as in contact with each other.

As shown in FIG. 4, as discussed above, a plurality of spline grooves 421 are provided on the portions of the surface of the second portion 428 of the rear wheel shaft 42 that are located between the right side 5231 of the right portion 523 of the member 52 and the left side 531 of the member 53. The spline grooves 421 are inclined at an angle relative to the axis L3. The inclination angle of the spline grooves 421 relative to the shaft L3 may be in the range of about 40 degrees to about 50 degrees, for example. As viewed from above the rear wheel shaft 42, the spline grooves 421 are disposed such that their left ends are located forward of their right ends.

A plurality of spline grooves 441 are provided on the inner periphery of the second gear 44. The spline grooves 441 are inclined at the same angle relative to the axis L3 as the spline grooves 421 on the rear wheel axis 42.

When the electric motorcycle 10 is standing still, the elastic member 51 is located at the rightmost position, as shown in FIG. 4. This state will be referred to as first state S1.

When the rider operates the vehicle such that the motor 32 produces driving power, this driving power is transmitted to the rear wheel shaft 42 via the power transmission mechanism 40, thus rotating the rear wheel 11R. More specifically, when the motor 32 produces driving power, the first gear 43 rotates in the rearward direction in synchronization with the rotation of the motor shaft 33 in the forward direction. Further, the rotation of the first gear 43 causes the intermediate shaft 41 fixed to the first gear 43 to rotate in the rearward direction. Further, the rotation of the intermediate shaft 41 in the rearward direction causes the second gear 44 to rotate in the forward direction. When the second gear 44 rotates in the forward direction, the rotating force of the second gear 44 is transmitted to the rear wheel shaft 42.

The rotating force of the second gear 44 is transmitted to the rear wheel shaft 42 via the mechanism 50 that tolerates a rotation phase difference. In the mechanism 50 that tolerates a rotation phase difference, the rear wheel shaft 42 and second gear 44 engage each other via the spline grooves 421 and 441 inclined relative to the axis L3 such that the rotating force of the second gear 44 is applied to the rear wheel shaft 42 in a direction inclined relative to the shaft. Thus, a portion of the rotating force of the second gear 44 is transmitted to the rear wheel shaft 42 as a force causing the second gear 44 to move in the direction of the axis L3 toward the left, and the remaining rotating force is transmitted thereto as a force causing the rear wheel shaft 42 to rotate about the axis L3.

The power transmission mechanism 40 includes the elastic member 51 which produces an elastic force pushing the second gear 44 toward the right. When the motor 32 begins to drive the mechanism, a portion of the rotating force of the second gear 44 is transmitted to the shaft as a force causing the second gear 44 to move in the direction of the axis L3 toward the left such that the elastic member 51 is pushed by the second gear 44 toward the left, thus increasing its elastic force. When the elastic force of the elastic member 51 increases, a portion of the rotating force of the second gear 44 (i.e. rotating force acting in an axial direction) and the elastic force of the elastic member 51 are eventually brought into balance such that the second gear 44 and rear wheel shaft 42 do not move any more relative to each other in an axial direction. The state at this moment is the second state S2 shown in FIG. 5. After the second gear 44 has reached the second state S2, the rotating force of the second gear 44 is transmitted as a force causing the rear wheel shaft 42 to rotate about the axis L3.

When the electric motorcycle 10 is travelling, in the drive unit 22, the second gear 44 and elastic member 51 are in the second state S2 shown in FIG. 5, as discussed above. It is now assumed that, when the electric motorcycle 10 is travelling, irregularities on the ground, for example, have caused the rear wheel 11R to leave the ground. When the rear wheel 11R leaves the ground, the friction force received by the rear wheel 11R from the ground during travelling becomes zero. This causes the rear wheel 11R to slip. Further, when the friction force received by the rear wheel 11R from the ground becomes zero, the second gear 44 only needs a smaller force to rotate the rear wheel shaft 42, and its force pushing the elastic member 51 decreases to that extent. Then, the elastic force of the elastic member 51 causes the second gear 44 to move toward the right. That is, the second gear 44 transitions from the second state S2 to the first state S1.

When the rear wheel 11R, being away from the ground, lands on the ground once again, then, the friction force and other forces produced between the ground and rear wheel 11R causes the rear wheel 11R to be loaded all of a sudden. At this moment, due to this sudden load on the rear wheel 11R, the rear wheel 11R may stop rotating temporarily. When the halt of the rotation of the rear wheel 11R suddenly stops the axial rotation of the rear wheel shaft 42, then, the engagement of the spline grooves 421 and 441 causes the second gear 44 to move to the left. That is, the second gear 44 transitions from the first state S1 to the second state S2. At this moment, as the second gear 44 moves in the direction of the axis L3, there is a phase difference between the rotation of the rear wheel 11R and the rotation of the motor 32. Thus, there is a time lag between the time at which the effect of the load applied to the rear wheel 11R (that is, temporary halt of the rear wheel shaft 42) occurs and the time at which this effect affects the driving of the motor 32 (that is, rotation of the second gear 44). During this time lag, the motorcycle 10 travels forward due to inertia. This removes the temporary halt of the rear wheel shaft 42, which starts to rotate once again.

After the second gear 44 has transitioned to the second state S2 and the rear wheel shaft 42 has started to rotate once again, the power transmission mechanism 40 of the drive unit 22 and the mechanism 50 that tolerates a rotation phase difference operate in the same manner as during normal travelling.

When a conventional electric motorcycle hits an obstacle, for example, and the rear wheel leaves the ground and then the rear wheel lands on the ground once again, which causes a sudden load on the rear wheel, and the effect of the load on the rear wheel is directly transmitted to the second gear and then to the motor, an overcurrent may flow in the rotor of the motor. As an overcurrent flows in the rotor, the motor may be temporarily uncontrollable.

In contrast, as described in “Operation of Mechanism that tolerates Rotation Phase Difference” described above, in the present preferred embodiment, the power transmission mechanism 40 operates in the following manner when the electric motorcycle 10 hits an obstacle, for example, and the rear wheel 11R leaves the ground: when the rear wheel 11R leaves the ground and then the rear wheel 11R lands on the ground once again and the rear wheel shaft 42 stops temporarily, there is a time lag between the time at which the effect of the load applied to the rear wheel 11R (that is, temporary halt of the rear wheel shaft 42) occurs and the time at which this effect affects the driving of the motor 32 (that is, rotation of the second gear 44). Thus, the power transmission mechanism 40 in the present preferred embodiment uses the mechanism 50 that tolerates a rotation phase difference described above to prevent overcurrent in the motor 32.

In the present preferred embodiment, the mechanism 50 that tolerates a rotation phase difference is located in the area where the second gear 44 and rear wheel shaft 42 exchange rotating forces. In the power transmission mechanism 40, torque increases as it goes from the motor shaft 33 toward the rear wheel shaft 42. The large torque of rotating forces exchanged by the second gear 44 and rear wheel shaft 42 makes it possible to reduce the distance by which the second gear 44 moves in the direction of the axis L3. This reduces the size of the drive unit 22 as measured in the left/right direction.

In the present preferred embodiment, an intermediate shaft 41 is provided between the motor shaft 33 and rear wheel shaft 42. The torque of driving power increases as the driving power is transmitted from the motor shaft 33 to the intermediate shaft 41, and the torque further increases as the driving power is transmitted from the intermediate shaft 41 to the rear wheel shaft 42, thus increasing the efficiency with which torque is amplified. This makes it possible to reduce the size of the drive unit 22 as measured in the left/right direction.

In the present preferred embodiment, the elastic member 51 preferably is a disc spring. Due to the large elastic modulus of a disc spring, the member has a large elastic force even if elastic deformation is small. Thus, a disc spring with a large elastic modulus is suitable in the rear wheel shaft 42 which exchanges driving power with a large torque.

In the present preferred embodiment, the spline grooves 421 on the rear wheel shaft 42 and the spline grooves 441 on the second gear 44 are preferably inclined at an angle ranging from about 40 degrees to about 50 degrees. Thus, a portion of the driving power transmitted to the rear wheel shaft 42 from the second gear 44 is able to be efficiently directed to an axial direction of the rear wheel shaft 42. Further, in the second state S2 shown in FIG. 5, all of the rotating force of the second gear 44 may be transmitted as a force to rotate the rear wheel shaft 42 about the axis L3; even then, the rotating force is transmitted from the second gear 44 to the rear wheel shaft 42 with good transmission efficiency since the spline grooves 421 and 441 are inclined at an angle ranging from about 40 degrees to about 50 degrees, for example.

The above preferred embodiment describes that the right side 449 of the second gear 44 preferably is in contact with the left side 531 of the member 53 when the mechanism is in the first state S1 shown in FIG. 4. However, the right side 449 of the second gear 44 need not be in contact with the left side 531 of the member 53. If the position of the second gear 44 in the first state S1 is to the right of the position thereof in the second state S2, it is possible to ensure that the state in which the elastic member 51 is at its natural length is represented by the first state S1 even if the right side 449 of the second gear 44 is not in contact with the left side 531 of the member 53.

Further, the above preferred embodiment describes that the left side 443 of the second gear 44 preferably is in contact with the right side 5231 of the right portion 523 of the member 52 when the mechanism is in the second state S2 shown in FIG. 5. However, the left side 443 of the second gear 44 need not be in contact with the right side 5231 of the right portion 523. If the position of the second gear 44 in the second state S2 is to the left of the position thereof in the first state S1, it is possible to ensure that the state in which the elastic force of the elastic member 51 is in balance with a portion of the rotating force of the second gear 44 (i.e. component in the direction of the axis L3) is represented by the second state S2.

The above preferred embodiment describes that the elastic member 51 preferably is a disc spring. However, the type of the elastic member 51 is not limited to disc spring. For example, the elastic member 51 may be a coil spring. However, the elastic member 51 is preferably a disc spring to minimize the size of the drive unit 22 as measured in the left/right direction.

### Second Preferred Embodiment

An electric motorcycle according to a second preferred embodiment of the present invention will be described below. The overall construction of the electric motorcycle according to the second preferred embodiment is the same as that of the electric motorcycle 10 according to the first preferred embodiment. In the electric motorcycle according to the second preferred embodiment, a drive unit 22A has a different construction from that of the drive unit 22 according to the first preferred embodiment.

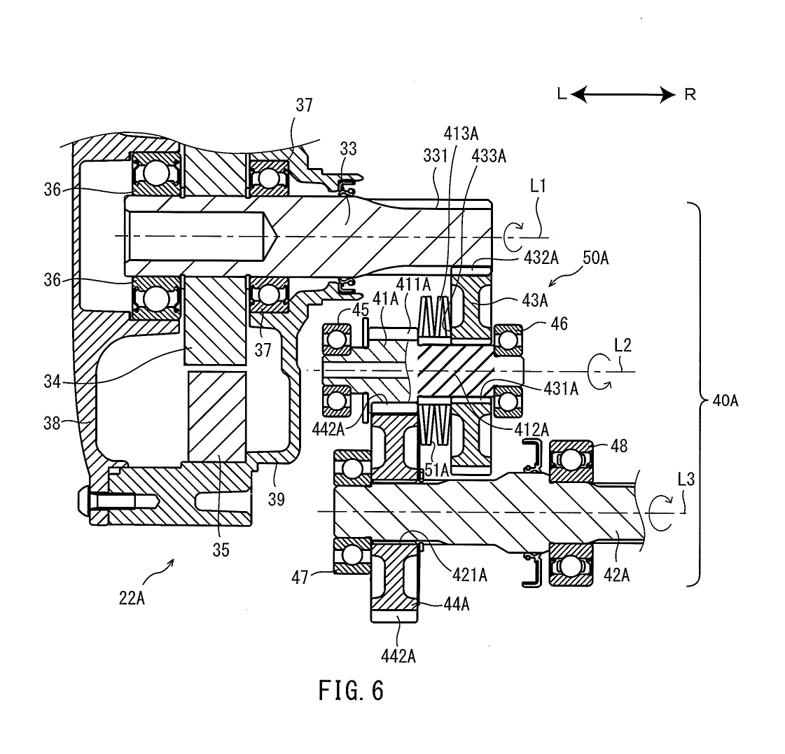

FIG. 6 shows the drive unit 22A according to the second preferred embodiment. Similar to the drive unit 22 according to the first preferred embodiment, the drive unit 22A includes a motor 32 and a power transmission mechanism 40A. The motor 32 has the same construction as in the first preferred embodiment.

Similar to the mechanism in the first preferred embodiment, the power transmission mechanism 40A includes a motor shaft 33 of the motor 32, an intermediate shaft 41A, a rear wheel shaft (driving shaft) 42A, a first gear 43A, and a second gear 44A. FIG. 6 shows a cross section of the drive unit 22A that includes an axis L1 which represents the shaft center of the motor shaft 33, an axis L2 which represents the shaft center of the intermediate shaft 41A and an axial L3 which represents the shaft center of the rear wheel shaft 42A.

While the mechanism 50 that tolerates a rotation phase difference in the first preferred embodiment is constructed on the rear wheel shaft 42, a mechanism 50A that tolerates a rotation phase difference in the second preferred embodiment is constructed on the intermediate shaft 41A. The mechanism 50A that tolerates a rotation phase difference will be described below. As shown in FIG. 6, the mechanism 50A that tolerates a rotation phase difference preferably includes of the intermediate shaft 41A, the first gear 43A and an elastic member 51A. FIG. 6 shows the mechanism 50A that tolerates a rotation phase difference in a state when the motor 32 is not rotating.

As shown in FIG. 6, gear grooves 411A are provided on a left portion of the intermediate shaft 41A. The gear grooves 411A engage gear grooves 442A provided on the outer periphery of the second gear 44A.

Spline grooves 412A are provided on the intermediate shaft 41A and located to the right of the gear grooves 411A. The spline grooves 412A will be described further below. For convenience, FIG. 6 shows the area where the spline grooves 421A are coupled to the first gear 43A as a line parallel or substantially parallel to the axis L2.

The first gear 43A includes a plurality of gear grooves 431A on its outer periphery. As shown in FIG. 6, the gear grooves 431A engage the gear grooves 331 on the motor shaft 33.

A plurality of gear grooves 431A are provided on the inner periphery of the first gear 43A. The gear grooves 431A engage the spline grooves 412A on the intermediate shaft 41A. The gear grooves 431A will be described further below.

The elastic member 51A is disposed around the intermediate shaft 41A. The elastic member 51A is able to be extended and contracted in the direction of the axis L2. The elastic member 51A preferably is a disc spring. The elastic member 51A is located between the right side 413A of the gear groove 411A portion and the left side 433A of the first gear 43A. The left end of the elastic member 51A is in contact with the right side 413A of the gear groove 411A portion. The right end of the elastic member 51A is in contact with the left side 433A of the first gear 43A.

As discussed above, a plurality of spline grooves 412A are provided on the intermediate shaft 41A. The spline grooves 412A are inclined at an angle relative to the axis L2. The inclination angle of the spline grooves 412A relative to the axis L2 preferably may be in the range of about 40 degrees to about 50 degrees, for example. As viewed from above the intermediate shaft 41A, the spline grooves 412A are disposed such that their left ends are located forward of their right ends.

Further, as discussed above, a plurality of gear grooves 431A are provided on the inner periphery of the first gear 43A. The gear grooves 431A are inclined at the same angle relative to the axis L2 as the spline grooves 412A on the intermediate shaft 41A.

In the second preferred embodiment, no mechanism that tolerates a rotation phase difference is provided on the rear wheel shaft 42A. Thus, spline grooves 421A extending parallel or substantially parallel to the axis L3 are provided on the rear wheel shaft 42A. The spline grooves 421A engage spline grooves provided on the inner periphery of the second gear 44A.

The operation of the mechanism 50A that tolerates a rotation phase difference is the same as the operation of the mechanism 50 that tolerates a rotation phase difference in the first preferred embodiment except that the rear wheel shaft 42 is changed to the intermediate shaft 41A, the second gear 44 is changed to the first gear 43A, and the elastic member 51 is changed to the elastic member 51A.

The power transmission mechanism 40A in the present preferred embodiment operates in the following manner when the electric motorcycle hits an obstacle, for example, and the rear wheel 11R leaves the ground: when the rear wheel 11R leaves the ground and then the rear wheel 11R lands on the ground once again and the rear wheel shaft 42A stops temporarily, there is a time lag between the time at which the effect of the load applied to the rear wheel 11R (that is, temporary halt of the rear wheel shaft 42A and intermediate shaft 41A) occurs and the time at which this effect affects the driving of the motor 32 (that is, rotation of the first gear 43A). Thus, the power transmission mechanism 40A in the present preferred embodiment uses the mechanism 50A that tolerates a rotation phase difference described above to prevent overcurrent in the motor 32.

### Third Preferred Embodiment

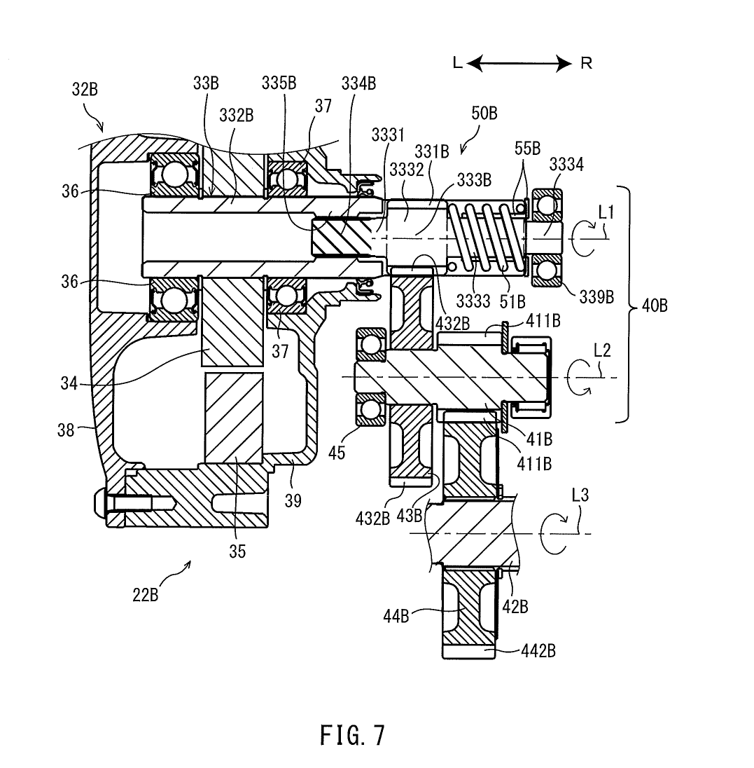

An electric motorcycle according to a third preferred embodiment of the present invention will be described below. The overall construction of the electric motorcycle according to the third preferred embodiment is the same as that of the electric motorcycle 10 in the first preferred embodiment. FIG. 7 shows a drive unit 22B in the third preferred embodiment. In the electric motorcycle according to the third preferred embodiment, the drive unit 22B has a different construction from that of the drive unit 22 in the first preferred embodiment.

As shown in FIG. 7, the power transmission mechanism 40B includes a motor shaft 33B of a motor 32B, an intermediate shaft 41B, a rear wheel shaft (driving shaft) 42B, a first gear 43B, and a second gear 44B. FIG. 7 shows a cross section of the drive unit 22B that includes an axis L1 which represents the shaft center of the motor shaft 33B, an axis L2 which represents the shaft center of the intermediate shaft 41B, and an axis L3 which represents the shaft center of the rear wheel shaft 42B.

The motor shaft 33B preferably includes a first motor shaft portion 332B and a second motor shaft portion 333B. The first motor shaft portion 332B is positioned with its shaft center consistent with the axis L1. The first motor shaft portion 332B has an annular cross section perpendicular to the axis L1. That is, the first motor shaft portion 332B has a columnar hole extending therethrough in the direction of the shaft center. The greater portion of the first motor shaft portion 332B is located within the space defined by the first and second motor case portions 38 and 39 of the motor 32. A plurality of spline grooves 335B are provided on the inner periphery of a right portion of the first motor shaft portion 332B.

The second motor shaft portion 333B is positioned with its shaft center consistent with the axis L1. The second motor shaft portion 333B preferably includes a first portion 3331, a second portion 3332, a third portion 3333 and a fourth portion 3334. The first portion 3331 includes the left end surface of the second motor shaft portion 333B. The second portion 3332 is connected to the first portion 3331 and is located to the right of the first portion 3331. The third portion 3333 is connected to the second portion 3332 and is located to the right of the second portion 3332. The fourth portion 3334 is connected to the third portion 3333 and is located to the right of the third portion 3333. The fourth portion 3334 includes the right end surface of the second motor shaft portion 332B.

The first portion 3331 is inserted into the hole of the first motor shaft portion 332B through its right end. Spline grooves 334B are provided on the outer periphery of the first portion 3331. The spline grooves 334B will be described further below.

A plurality of gear grooves 331B are provided on the second portion 3332. The gear grooves 331B extend parallel or substantially parallel to each other. The gear grooves 331B extend parallel or substantially parallel to the axis L1.

An annular metal cover 55B is fixed to the outer periphery of the third portion 3333 to cover the outer periphery. The metal cover 55B is pushed into the third portion 3333. Portions of the metal cover 55B located adjacent the right end of the third portion 3333 are bent along a plane perpendicular or substantially perpendicular to the axis L1 to expand away from the axis L1. An elastic member 51B, described further below, is attached to the outer periphery of the third portion 3333.

A bearing 339B is pushed into the fourth portion 3334. The outer ring of the bearing 339B is fixed to the housing 49 (not shown in FIG. 7; see FIG. 3).

As shown in FIG. 7, the intermediate shaft 41B is positioned with its shaft center consistent with the axis L2. The first gear 43B is fixed to the intermediate shaft 41B. The first gear 43B is pushed into the intermediate shaft 41B.

A plurality of gear grooves 432B are provided on the outer periphery of the first gear 43B. The gear grooves 432B extend parallel or substantially parallel to each other. The gear grooves 432B extend in the direction of the axis L2. The gear grooves 432B engage the gear grooves 331B provided on the second portion 3332 of the second motor shaft portion 333B.

A plurality of gear grooves 411B are provided on the outer periphery of the intermediate shaft 41B. The gear grooves 411B extend parallel or substantially parallel to each other. The gear grooves 411B extend in the direction of the axis L2. The gear grooves 411B are located to the right of the portion of the shaft to which the first gear 43B is attached.

The construction of the rear wheel shaft 42B is the same as that of the rear wheel shaft 42A in the second preferred embodiment shown in FIG. 6. The rear wheel shaft 42B is positioned with its shaft center consistent with the axis L3. The second gear 44B is fixed to the rear wheel shaft 42B. A plurality of gear grooves 442B are provided on the outer periphery of the second gear 44B. The gear grooves 442B engage the gear grooves 411B on the intermediate shaft 41B.

In the power transmission mechanism 40B, the motor 32B drives the motor shaft 33B to cause the shaft to rotate in the forward direction. The rotation of the motor shaft 33B in the forward direction is transmitted to the first gear 43B in the form of rotation in the rearward direction. As the first gear 43B rotates in the rearward direction, the intermediate shaft 41B rotates in the rearward direction. The rotation of the intermediate shaft 41B in the rearward direction is transmitted to the second gear 44B in the form of rotation in the forward direction. As the second gear 44B rotates in the forward direction, the rear wheel shaft 42B rotates in the forward direction, causing the electric motorcycle 10 to advance.

While the mechanism 50 that tolerates a rotation phase difference in the first preferred embodiment is constructed on the rear wheel shaft 42, a mechanism 50B that tolerates a rotation phase difference in the third preferred embodiment is constructed on the motor shaft 33B. The mechanism 50B that tolerates a rotation phase difference will be described below. As shown in FIG. 7, the mechanism 50B that tolerates a rotation phase difference preferably includes the motor shaft 33B and an elastic member 51B. FIG. 7 shows the mechanism 50B that tolerates a rotation phase difference in a state when the motor 32B is not rotating. The construction of the motor shaft 33B is described above.

As discussed above, the elastic member 51B is disposed on the third portion 3333 of the second motor shaft portion 333B. The elastic member 51B is located between the right end of the gear groove 331B portion and the left side of the bent portion of the metal cover 55B. The elastic member 51B is annular in shape. The elastic member 51B is able to be extended and contracted in the direction of the axis L1. The elastic member 51B may be a coil spring, for example.

The spline grooves 334B provided on the first portion 3331 of the second motor shaft portion 333B are inclined at an angle relative to the axis L1. The inclination angle of the spline grooves 334B relative to the axis L1 preferably may be in the range of about 40 degrees to about 50 degrees, for example. As viewed from above the second motor shaft portion 333B, the spline grooves 334B are disposed such that their left ends are located forward of their right ends.

Further, as discussed above, a plurality of spline grooves 335B are provided on the inner periphery of the right portion of the first motor shaft portion 332B. The spline grooves 335B are inclined at the same angle relative to the axis L1 as the spline grooves 334B on the second motor shaft portion 333B. Thus, the spline grooves 335B engage the spline grooves 334B on the second motor shaft portion 333B. For convenience, FIG. 7 shows the area where the spline grooves 334B and 335G are coupled to each other as a line parallel or substantially parallel to the axis L1.

When the electric motorcycle 10 is standing still, the elastic member 51B is at its natural length or has the minimum elastic force, as shown in FIG. 7. When the motor 32B, standing still, starts to drive the vehicle, the rotation of the rotor 34 causes the first motor shaft portion 332B to rotate in the forward direction.

The rotating force of the first motor shaft portion 332B in the forward direction is transmitted to the second motor shaft portion 333B via the engagement of the spline grooves 335B and the spline grooves 334B on the second motor shaft portion 333B. Since the spline grooves 334B and 335B are inclined relative to the axis L1, a portion of the rotating force acts as a force causing the second motor shaft portion 333B to rotate in the forward direction, while the remaining rotating force acts as a component of the force causing the second motor shaft portion 333B to move to the right in the direction of the axis L1. Thus, the elastic member 51B is pushed by the right side of the second portion 3332 of the second motor shaft portion 333B so as to be contracted. When the magnitude of the a portion of the rotating force that causes the second motor shaft portion 333B to move to the right in the direction of the axis L1 and the elastic force of the elastic member 51B are in balance, the rotating force is used to rotate the second motor shaft portion 333B in the forward direction.

It is assumed that, when the electric motorcycle 10 is travelling, it has hit an obstacle, for example, causing the rear wheel 11R to leave the ground. When the rear wheel 11R leaves the ground, the friction force received by the rear wheel 11R from the ground during travelling becomes zero. This causes the rear wheel 11R to slip such that the speed of rotation rapidly increases. Further, when the friction force received by the rear wheel 11R from the ground becomes zero, the elastic member 51B causes the second motor shaft portion 333B to move toward the left. This decreases the elastic force of the elastic member 51B.

When the rear wheel 11R, being spaced away from the ground, lands on the ground once again, then, the friction force and other forces produced between the ground and rear wheel 11R causes the rear wheel 11R to be loaded all of a sudden. At this moment, due to this sudden load on the rear wheel 11R, the rear wheel 11R may stop rotating temporarily. When the halt of the rotation of the rear wheel 11R suddenly stops the axial rotation of the rear wheel shaft 42B, intermediate shaft 41B and second motor shaft portion 333B, then, the engagement of the spline grooves 335B and 334B causes the second motor shaft portion 333B to move to the right. At this moment, as the second motor shaft portion 333B moves in the direction of the axis L1, there is a phase difference between the rotation of the rear wheel 11R and the rotation of the motor 32B. Thus, there is a time lag between the time at which the effect of the load applied to the rear wheel 11R (that is, temporary halt of the rear wheel shaft 42B, intermediate shaft 41B and second motor shaft portion 333B) occurs and the time at which this effect affects the driving of the motor 32 (that is, the first motor shaft portion 332B). During this time lag, the electric motorcycle 10 travels forward due to inertia. This removes the temporary halt of the rear wheel shaft 42B, intermediate shaft 41B and second motor shaft portion 333B, which starts to rotate once again.

The power transmission mechanism 40B in the present preferred embodiment operates in the following manner when the electric motorcycle hits an obstacle, for example, and the rear wheel 11R leaves the ground: when the rear wheel 11R leaves the ground and then the rear wheel 11R lands on the ground once again and the rear wheel shaft 42B stops temporarily, there is a time lag between the time at which the effect of the load applied to the rear wheel 11R (that is, temporary halt of the rear wheel shaft 42B, intermediate shaft 41B and second motor shaft portion 333B) occurs and the time at which this effect affects the driving of the motor 32 (that is, the first motor shaft portion 332B). Thus, the power transmission mechanism 40B in the present preferred embodiment uses the mechanism 50B that tolerates a rotation phase difference described above to prevent overcurrent in the motor 32.

### Other Preferred Embodiments

The above preferred embodiments describe that the drive unit 22 preferably is located to the left of the rear wheel 11R. Alternatively, the drive unit 22 may be located to the right of the rear wheel 11R.

The above preferred embodiments describe that the power transmission mechanism preferably includes a motor shaft, an intermediate shaft and a rear wheel shaft. However, the power transmission mechanism may not include an intermediate shaft. In such implementations, the rotating force of the motor shaft is transmitted to the rear wheel shaft via gears. In implementations where the power transmission mechanism includes no intermediate shaft, the mechanism that tolerates a rotation phase difference may be provided on the rear wheel shaft, or provided on the motor shaft.

The present application claims priority to Japanese Patent Application No. 2015-112567 filed on Jun. 2, 2015, the entire contents of which are hereby incorporated by reference.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A straddled electric vehicle comprising:
a motor;
a driving wheel; and
a power transmission mechanism including a plurality of shafts that transmit the driving power from the motor to the driving wheel; wherein
the power transmission mechanism includes:
a first shaft including spline gears on a shaft surface, the spline gears being inclined relative to an axial direction;
a rotating member attached to the first shaft and including spline gears engageable with the spline gears on the first shaft, the rotating member being capable of exchanging a rotating force with the first shaft; and
an elastic member capable of biasing one of the rotating member attached to the first shaft and the first shaft toward one axial direction; wherein
the spline gears are inclined so as to move the rotating member or the first shaft toward the other axial direction when the driving wheel is rotating in a direction causing the straddled electric vehicle to advance and the rotating member or the first shaft works to maintain a speed of rotation of the driving wheel as the speed of rotation is decreasing.

2. The straddled electric vehicle according to claim 1, wherein the rotating member or the first shaft moves in the other axial direction while resisting an elastic force of the elastic member.

3. The straddled electric vehicle according to claim 1, wherein, when the rotating member or the first shaft is not transmitting the driving power to the driving wheel, the elastic member applies no or substantially no elastic force to the rotating member or the first shaft.

4. The straddled electric vehicle according to claim 1, wherein, out of the rotating member and the first shaft, the rotating member moves in the other axial direction.

5. The straddled electric vehicle according to claim 4, wherein the elastic member is a disc spring that applies an elastic force pushing the rotating member in the one direction.

6. The straddled electric vehicle according to claim 1, wherein the plurality of shafts include a motor shaft capable of being rotated by the driving power of the motor and a driving shaft capable of rotating the driving wheel, wherein the first shaft is the driving shaft.

7. The straddled electric vehicle according to claim 6, wherein
the plurality of shafts further includes an intermediate shaft capable of transmitting the driving power transmitted from the motor shaft to the driving shaft; and
the rotating member engaging the driving shaft is a gear coaxial with the driving shaft.

8. The straddled electric vehicle according to claim 6, wherein the spline gears provided on the driving shaft and the rotating member are inclined relative to the axial direction by about 40 degrees to about 50 degrees.

9. The straddled electric vehicle according to claim 1, wherein
the plurality of shafts include a motor shaft capable of being rotated by the driving power of the motor, a driving shaft capable of rotating the driving wheel, and an intermediate shaft capable of transmitting the driving power transmitted from the motor shaft to the driving shaft; and
the first shaft is the intermediate shaft.

10. The straddled electric vehicle according to claim 1, wherein
the plurality of shafts include a motor shaft capable of being rotated by the driving power of the motor and a driving shaft capable of rotating the driving wheel;
the first shaft is the motor shaft; and
the rotating member engaging the motor shaft is a member including a rotor of the motor.

11. The straddled electric vehicle according to claim 10, wherein the elastic member produces an elastic force pushing the motor shaft toward the one direction.
